(19) United States
(12) Patent Application Publication
(10) Pub. No.: US 2011/0020560 A1
(43) Pub. Date: Jan. 27, 2011

(54) Method for Manufacturing a Run-In Coating

(75) Inventors: Manfred Daeubler, Dachau (DE); Horst Mueller-Wittek, Gelsenkirchen (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 12/086,110

(22) PCT Filed: Nov. 30, 2006
(86) PCT No.: PCT/DE2006/002122

§ 371 Date: Sep. 21, 2009

(30) Foreign Application Priority Data
Dec. 7, 2005 (DE) 10 2005 058 324.5

(51) Int. Cl. C23C 4/18; B05D 3/02; B05D 3/10

(52) U.S. Cl. 427/446; 427/372.2; 427/337

(57) ABSTRACT

A method for the production of a run-in coating is provided, whereby a metallic run-in coating material is provided on a component on the stator side of a turbomachine, especially a gas turbine. According to an embodiment of the invention, the provided run-in coating undergoes a heat treatment for purposes of improving its run-in characteristics.

The invention relates to a method for the production of a run-in coating according to the generic part of Claim 1.

Turbomachines such as, for instance, gas turbines, normally comprise several rotating turbine blades as well as several stationary guide blades, whereby the turbine blades rotate together with a rotor and whereby the turbine blades as well as the guide blades are surrounded by a stationary housing. In order to improve the performance, it is important to optimize all of the components and subsystems. This also includes the so-called sealing systems. An especially problematic aspect with turbomachines consists of maintaining a minimum clearance between the rotating turbine blades and the stationary housing of a high-pressure compressor. In fact, high absolute temperatures and temperature gradients are encountered with high-pressure compressors, which makes it more difficult to maintain the clearance between the rotating turbine blades and the stationary housing. This is due, among other things, to the fact that compressor blades dispense with shrouds of the kind employed for turbine blades.

As already mentioned, blades in a compressor are not fitted with a shroud. This is why the ends or tips of the blades are exposed to direct friction contact with the housing in the case of so-called rubbing in the stationary housing. Such rubbing of the tips of the blades in the housing is caused by manufacturing tolerances when a minimum radial clearance is established. Since material is abraded from the tips of the blades due to friction contact, an undesired enlargement of the clearance can occur over the entire circumference of the housing and the rotor. In order to prevent this, it is already a known procedure from the state of the art to armor the ends or tips of the turbine blades with a hard coating or with abrasive particles.

Another possibility to avoid wear and tear at the tips of the blades and to ensure optimal sealing between the ends or tips of the turbine blades and the stationary housing consists of coating the housing with a so-called run-in coating. When material is abraded from a run-in coating, the radial clearance is not enlarged over the entire circumference, but rather, usually only in the shape of a crescent. This prevents a drop in the performance of the engine. Housings having a run-in coating are known from the state of the art.

Run-in coatings known from the state of the art for compressors are normally made of a metallic material that is applied onto a component of the housing on the stator side by means of thermal spraying. However, during the operation of a turbomachine, it can be seen that, as a function of the operating temperature, the run-in behavior of such run-in coatings changes to such an extent that they display an increasing hardness as the operating temperatures rise, as a result of which there is a risk of damage to the turbine blades as they rub against the run-in coating. Consequently, there is a need for run-in coatings that have an appropriate hardness and thus good run-in characteristics over the entire range of the temperatures that occur during operation, thereby reducing the risk of damage to the blades due to rubbing against the run-in coating.

Before this backdrop, the objective of the present invention is to create a novel method for the production of a run-in coating.

This objective is achieved by means of a method for the production of a run-in coating as set forth in claim 1. According to the invention, the provided run-in coating undergoes a heat treatment for purposes of improving its run-in characteristics. The run-in coating produced according to the invention is preferably used in compressors or in low-pressure turbines.

As set forth in the present invention, it is proposed that, for example, a newly produced or repaired run-in coating undergoes a heat treatment in order to improve its run-in characteristics. The heat treatment pre-sets the hardening and oxidation of the metallic matrix of metallic run-in coatings, as a result of which the desired hardness of the run-in coating is ultimately set and the run-in characteristics of the run-in coating are improved and stabilized. The heat treatment of the provided run-in coating causes it to undergo an artificial ageing process so to speak, so that it then exhibits stable run-in behavior during later operation.

According to a preferred refinement of the invention, the heat treatment is carried out at a process temperature that lies above the maximum temperature to which the run-in coating is exposed during the operation of the turbomachine. In this context, the process temperature of the heat treatment is 50° C. to 200° C. [90° F. to 360° F.] higher than the maximum operating temperature of the run-in coating. The duration of the heat treatment lies between 1 hour and 200 hours.

According to an advantageous refinement of the invention, the provided run-in coating is rinsed in a chemical solution or chemical bath prior to the heat treatment. This makes it possible to shorten the duration of the subsequent heat treatment.

The present invention relates to a method for the production of a run-in coating of a component on the stator-side of a turbomachine, especially on a section of the housing of a gas-turbine aircraft engine. According to the invention, after a newly produced or repaired run-in coating has been provided, it undergoes a heat treatment to optimize its run-in coating characteristics. Here, the heat treatment is carried out at a process temperature that is higher than the maximum temperature to which the run-in coating is exposed during the operation of the turbomachine. As a result, the hardening as well as the oxidation of the metallic matrix can be pre-set for the run-in coatings made of a metallic material, in other words, for the metallic run-in coatings, so that the run-in coating has improved and stabilized run-in characteristics. The hardness of the metallic run-in coatings is optimized by the heat treatment carried out at a process temperature above the maximum operating temperature of the run-in coating to such an extent that the run-in coating is capable of running in, even at high operating temperatures and this property is retained over the service life of the turbomachine.

The hardness of the run-in coating that sets in during the heat treatment is determined by the overlapping of two effects, namely, the hardening and the oxidation of the run-in coating, whereby, as the duration of the heat treatment increases, the hardening raises the hardness of the run-in coating, whereas the oxidation lowers the hardness of the run-in coating. A systematic selection of the duration of the heat treatment makes it possible to precisely set the hardness of the run-in coating.

As the metallic run-in coating, preferably a porous run-in coating made of a NiCrAl material or of a CoNiCrAlY-hBN material is provided by means of thermal spraying, and the run-in coating then undergoes the heat treatment.

The process temperature of the heat treatment is 50° C. to 200° C. [90° F. to 360° F.], preferably 100° C. to 150° C. [180° F. to 270° F.] higher than the maximum operating temperature of the run-in coating.

If the run-in coating is exposed to operating temperatures of, for instance, between 450° C. and 650° C. [842° F. and 1202° F.] during the operation of the turbomachine, then the heat treatment of the run-in coating is preferably carried out at a process temperature between 600° C. and 800° C. [1112° F. and 1472° F.]. In the case of maximum operating temperatures of 650° C. [1202° F.], the heat treatment preferably takes place at 750° C. [1382° F.].

The heat treatment of the provided run-in coating is carried out for a duration ranging from 1 hour to 200 hours, preferably for a duration of between 2 hours and 20 hours. The higher the process temperature of the heat treatment, the shorter its duration.

In the case of multistage compressors whose individual stages are exposed to different maximum operating temperatures, the process temperature of the heat treatment of the run-in coating of the stage in question is adapted to the corresponding maximum operating temperature.

Accordingly, by means of the method according to the invention, for example, a provided run-in coating that has been newly produced or repaired undergoes a heat treatment after it has been provided. In this context, the heat treatment takes place at a process temperature that is higher than the maximum operating temperature of the run-in coating and it is carried out for a duration adapted to the temperature in question. As a result, the provided run-in coating undergoes an artificial ageing process which ultimately optimizes and stabilizes its run-in characteristics.

According to an advantageous refinement of the invention, a provided, porous run-in coating is rinsed in a chemical solution prior to the heat treatment. The rinsing is followed by a drying procedure and subsequently by the heat treatment, whereby, owing to capillary effects, the solution remains in the pores of the run-in coating after the drying procedure. The rinsing shortens the duration of the subsequent heat treatment since the solution promotes especially the oxidation of the metallic matrix.

The rinsing can be done, for example, in a solution of demineralized water and sodium hydroxide or in a sodium hydroxide solution. As an alternative, rinsing can be done in diethylene glycol monobutyl ether or in a solution of sodium hydroxide and monophenyl glycol and sodium cumene sulfonate.

1-14. (canceled)

15. A method for the production of a run-in coating comprising:
providing a metallic run-in coating material on a component on the stator side of a turbomachine; and
applying a heat treatment to the provided metallic run-in coating to improve its run-in characteristics.

16. The method as recited in claim 15, wherein the turbomachine is a gas turbine.

17. The method as recited in claim 15, wherein the step of applying a heat treatment is carried out at a process temperature that lies above the maximum temperature to which the run-in coating is exposed during the operation of the turbomachine.

18. The method as recited in claim 17, wherein the process temperature of the heat treatment is 50° C. to 200° C., or between 90° F. to 360° F., higher than the maximum operating temperature of the run-in coating.

19. The method as recited in claim 18, wherein the process temperature of the heat treatment is 100° C. to 150° C., or between 180° F. to 270° F., higher than the maximum operating temperature of the run-in coating.

20. The method as recited in claim 18, wherein the process temperature of the heat treatment lies between 600° C. and 800° C., or between 1112° F. and 1472° F.

21. The method as recited in claim 15, wherein the step of applying a heat treatment is carried out for a duration ranging from 1 hour to 200 hours.

22. The method as recited in claim 21, wherein the step of applying a heat treatment is carried out for a duration of between 2 hours and 20 hours.

23. The method as recited in claim 21, wherein the duration of the step of applying a heat treatment is adapted such that, the higher the process temperature of the heat treatment, the shorter its duration.

24. The method as recited in claim 15, wherein the metallic run-in coating is a porous run-in coating.

25. The method as recited in claim 24, wherein the metallic nm-in coating is applied via thermal spraying.

26. The method as recited in claim 15, further comprising rinsing the provided run-in coating in a chemical solution prior to the step of applying a heat treatment.

27. The method as recited in claim 26, further comprising providing a drying procedure following the step of rinsing step and subsequently followed by the step of applying a heat treatment.

28. The method as recited in claim 26, wherein the chemical solution of the rinsing step is a solution of demineralized water and sodium hydroxide or in a sodium hydroxide solution.

29. The method as recited in claim 26, wherein the chemical solution of the rinsing step is diethylene glycol monobutyl ether.

30. The method as recited in claim 26, wherein the chemical solution of the rinsing step is a solution of sodium hydroxide and monophenyl glycol and sodium cumene sulfonate.
